(19) United States
(12) Patent Application Publication
(10) Pub. No.: US 2025/0373427 A1
(43) Pub. Date: Dec. 4, 2025

(54) FORMING AND VALIDATING A MESSAGE OF A MEASUREMENT DEVICE

(71) Applicant: Emerson Automation Solutions Measurement Systems & Services LLC, Houston, TX (US)

(72) Inventors: Gary Thomson COLLISTER, Larbert (GB); Samer EL ISSA, Richmond, TX (US)

(73) Assignee: Emerson Automation Solutions Measurement Systems & Services LLC, Houston, TX (US)

(21) Appl. No.: 18/874,352

(22) PCT Filed: Jun. 29, 2022
(86) PCT No.: PCT/US2022/035538

§ 371 Date: Dec. 12, 2024

(51) Int. Cl. H04L 9/32; H04L 9/40

(52) U.S. Cl. CPC H04L 9/321; H04L 63/0428

(57) ABSTRACT

A method for forming a message from a measurement device for data validation is provided. The method includes obtaining a previously determined unique identification of the measurement device, obtaining measurement data of the measurement device, and combining the previously determined unique identification of the measurement device with the measurement data.

### TECHNICAL FIELD

The embodiments described below relate to messages provided by measurement devices and, more particularly, to forming and validating a message of a measurement device.

### BACKGROUND

Measurement devices are typically calibrated and maintained by various services. As a result, calibrations and maintenance records of a particular measurement device may or may not be available to other organizations. For example, a manufacturer of the measurement device may calibrate the measurement device and make the calibration record available to a purchaser of the measurement device. The purchaser may be able to obtain the records due to contractual relationships with the manufacturer. However, other organizations, such as governmental organizations, may need to rely on the customer acting as an intermediary that provides the records. To obtain such records, the customer may refer to a manufacturer's serial number of the measurement device. The serial number may be assigned by the manufacturer to the measurement device prior to the measurement device being shipped to the customer.

Additionally, the measurement device may be used to convey a material that is part of a transaction. For example, a Coriolis meter may be used in custody transfers of hydrocarbons or petroleum liquids from a marine vessel to a shore tank. The transfer of the hydrocarbons may involve a conveyance of a significant mass of the hydrocarbons and therefore may involve a significant pecuniary interest of stakeholders in a transaction. As a result, the stakeholders are significantly motivated to ensure that total measured mass value of the custody transfer is correct. Ensuring that the total measured mass value is correct necessarily requires that records associated with the custody transfer are reliable.

For example, the contracting (e.g., buyer, seller, docks, shipping company, etc.) and third parties (e.g., government collecting taxes) of the custody transfer may wish to accurately record the transaction details in a way that could not be subsequently altered and is available without permission from either party. By way of illustration, a transferee may wish to convey to a customer reliable information about the hydrocarbons based on the most recent custody transfer in lieu of, for example, sampling the hydrocarbons. Additionally, or alternatively, the contracting parties of the custody transfer may wish to verify the calibration of the meter performing such a measurement to ensure that the correct amount of mass is being measured.

Such verification may be viewed as relying on validating that a measurement device is approved to provide a message and validating that the message was provided by the measurement device. Accordingly, there is a need to form and validate a message of a measurement device.

### SUMMARY

A method for forming a message from a measurement device for data validation is provided. According to an embodiment, the method comprises obtaining a previously determined unique identification of a measurement device, obtaining measurement data of the measurement device, and combining the previously determined unique identification of the measurement device with the measurement data.

A measurement device configured to form a message is provided. According to an embodiment, the measurement device comprises a memory configured to store a unique identification of the measurement device, and a processor communicatively coupled to the memory, the processor being configured to perform the method as described in the foregoing.

A decentralized network data gateway configured to form a message is provided. According to an embodiment, the decentralized network data gateway comprises a memory configured to store a unique identification of the measurement device and a processor communicatively coupled to the memory, the processor being configured to perform the method of one of the foregoing.

A method for data validation of a message from a measurement device is provided. According to an embodiment, the method comprises receiving the message from the measurement device, obtaining, from the message, a previously determined unique identification of the measurement device, comparing the previously determined unique identification of the measurement device obtained from the message with a whitelisted previously determined unique identification, and determining if the previously determined unique identification of the measurement device obtained from the message matches the whitelisted previously determined unique identification.

A decentralized network data gateway for validating a message from a measurement device is provided. According to an embodiment, the decentralized network data gateway comprises a memory configured to store a whitelist containing a whitelisted previously determined unique identification of the measuring device, and a processor communicatively coupled to the memory, the processor being configured to perform the method as described in the foregoing.

### ASPECTS

According to an aspect, a method for forming a message from a measurement device for data validation comprises obtaining a previously determined unique identification of a measurement device, obtaining measurement data of the measurement device, and combining the previously determined unique identification of the measurement device with the measurement data.

Preferably, obtaining the previously determined unique identification of the measurement device comprises reading the previously determined unique identification from one or more registers of the measurement device.

Preferably, the previously determined unique identification of the measurement device is one of a public key obtained from a decentralized network and a serial number obtained from the measurement device.

Preferably, the serial number of the measurement device is previously associated with the public key.

Preferably, the method further comprises obtaining a checksum of the measurement device and combining the checksum with the previously determined unique identification of the measurement device.

Preferably, the checksum comprises one of a firmware checksum and a configuration checksum of the measurement device.

Preferably, the method further comprises securing the message for transmission over a secure channel to a cloud decentralized network.

Preferably, securing the message for transmission over the secure channel to the cloud decentralized network comprises securing the message for transmission to an internet-of-things hub communicatively coupled to the cloud decentralized network.

According to an aspect, a measurement device configured to form a message comprises a memory configured to store a unique identification of the measurement device, and a processor communicatively coupled to the memory, the processor being configured to perform the method as described in the foregoing.

According to an aspect, a decentralized network data gateway configured to form a message comprises a memory configured to store a unique identification of the measurement device, and a processor communicatively coupled to the memory, the processor being configured to perform the method as described in the foregoing.

According to an aspect, a method for data validation of a message from a measurement device comprises receiving the message from the measurement device, obtaining, from the message, a previously determined unique identification of the measurement device, comparing the previously determined unique identification of the measurement device obtained from the message with a whitelisted previously determined unique identification, and determining if the previously determined unique identification of the measurement device obtained from the message matches the whitelisted previously determined unique identification.

Preferably, the message further comprises at least one checksum of a measurement device data.

Preferably, the method further comprises comparing the at least one checksum of the measurement device data with a signed checksum stored in a memory of a decentralized network data gateway.

Preferably, the at least one checksum of a measurement device data comprises at least one of a firmware checksum and a configuration checksum.

Preferably, the method further comprises obtaining a whitelist containing the whitelisted previously determined unique identification from a cloud decentralized network.

Preferably, the method further comprises storing in a secure storage of a decentralized network data gateway the whitelist containing the whitelisted previously determined unique identification.

According to an aspect, a decentralized network data gateway for validating a message from a measurement device comprises a memory configured to store a whitelist containing a whitelisted previously determined unique identification of the measuring device, and a processor communicatively coupled to the memory, the processor being configured to perform the method as described in the foregoing.

### BRIEF DESCRIPTION OF THE DRAWINGS

The same reference number represents the same element on all drawings. It should be understood that the drawings are not necessarily to scale.

FIG. 1 shows a front perspective view of a measurement device 5 configured to form a message.

FIG. 2 shows an exemplary controller-peripheral network 200.

FIGS. 3A and 3B show a memory 300 in single register form (FIG. 3A) and multiple register form (FIG. 3B) for forming a message from a measurement device.

FIG. 4 shows a system 400 including a decentralized network 410.

FIGS. 5 and 6 show an undivided unique identification register 500 and a divided unique identification register 600.

FIG. 7 shows a typical measurement system 700.

FIG. 8 shows a block diagram of a decentralized network measurement system 800 configured for data validation of a message from a measurement device 805.

FIG. 9 shows a detailed view of the decentralized network data gateway 810.

FIG. 10. shows a flow diagram view of the decentralized network measurement system 800.

FIG. 11 shows a data flow 1100 of a calibration report according to the detailed view of the cloud decentralized network 820.

FIG. 12 shows a method 1200 for forming a message from a measurement device for data validation.

FIG. 13 shows a method 1300 for data validation of a message from a measurement device.

FIG. 14 shows a measurement device 1400 configured to form a message of the measurement device 1400.

FIG. 15 shows a decentralized network data gateway 1500 configured to validate a message of a measurement device, such as the measurement device 1400 described above.

### DETAILED DESCRIPTION

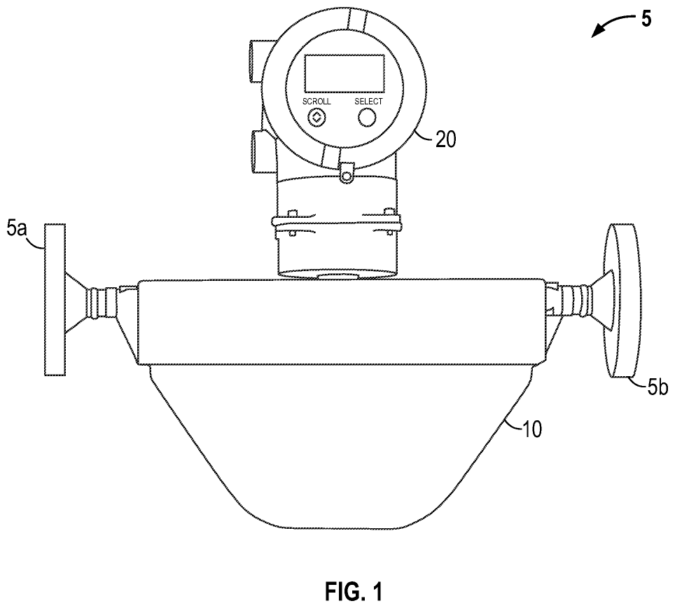

FIGS. 1-15 and the following description depict specific examples to teach those skilled in the art how to make and use the best mode of embodiments for forming and validating a message of a measurement device. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of forming and validating the message of the measurement device. As a result, the embodiments described below are not limited to the specific examples described below, but only by the claims and their equivalents.

A message may be provided by a measurement device that, for example, includes measurement, device profile, calibration, or the like, data. The message may be formed according to a protocol that allows for the data to be validated prior to being recorded to another system that is able to communicate with various stakeholders and non-stakeholders. Such formatting and validation may be particularly useful where the data is recorded in an immutable form in a decentralized or trustless system. That is, if the data provided can be validated as being, for example, from an approved measurement device and has not been altered, then a value of the data recorded to the decentralized system may have significantly more value than data that is not validated. In other words, the combination of forming the message for recording and validating the message from the measurement system and utilizing a decentralized system to record the data in the message may significantly improve the value of the data to the stakeholders. As can be appreciated, the measurement devices may be part of a controller-peripheral network, such as a Modbus network, which can affect how the message is formed, as is described in the following.

### Controller-Peripheral Network

FIG. 1 shows a front perspective view of a measurement device 5 configured to form a message. As shown in FIG. 1, the measurement device 5 is a meter that measures properties of a material flowing through the meter. With more particularity, the measurement device 5 is shown as a Coriolis flow meter. Accordingly, the meter shown in FIG. 1 is configured to measure a density and a mass flow rate of a fluid. However, any suitable measurement device may be employed. In the embodiment shown, the material may flow through the measurement device 5 via inlet 5a and outlet 5b. In alternative embodiments, other types of equipment, such as tuning fork densitometers, flow control valves and systems, ultrasonic flow meters, pressure transducers, temperature sensors, or the like, may be coupled to the measurement device 5.

As shown in FIG. 1, the measurement device 5 comprises an interface 20 communicatively coupled to a sensor assembly 10. The interface 20 can send and/or receive signals from the sensor assembly 10. The signals can include, for example, measurement values that represent properties of the material flowing through the measurement device 5. Additionally, or alternatively, the signals can include, for example, a drive signal, flow control signal (where the measurement device 5 includes flow control devices or the like), or other signals, that are sent to the sensor assembly 10. The signals can be electrical, optical, or any other appropriate form that may be transmitted through a conductor, wireless communication link, etc.

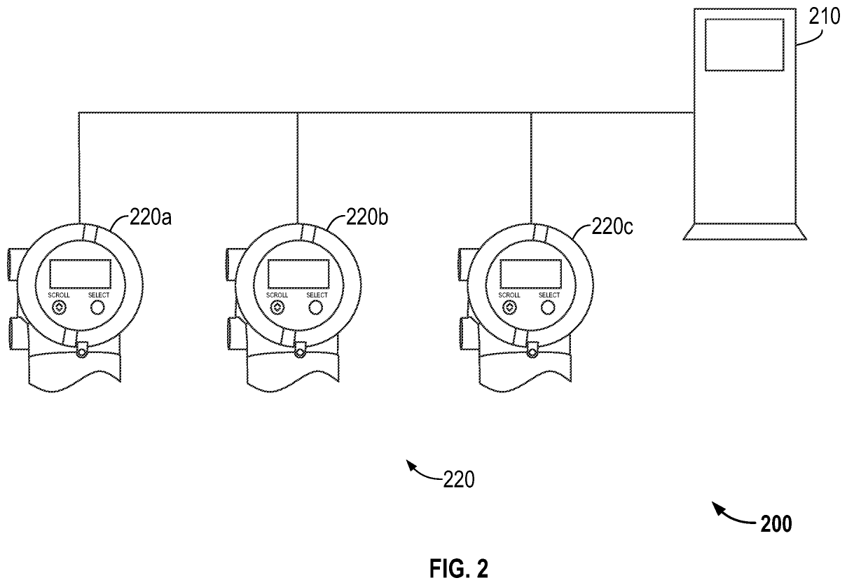

In the embodiment shown, the interface 20 is proximate the sensor assembly 10. In alternative embodiments, the interface 20 may be at a location that is not proximate the sensor assembly 10. For example, the interface 20 may be in a control room that is remote from the sensor assembly 10, where the interface 20 is advantageously shielded from dangerous or harmful environments. In addition, the interface 20 may be accessed remotely, which may be advantageous for users that are, for example, comparing data obtained from a different measurement device dispersed over a large area. Accordingly, the measurement device 5 may be part of a controller-peripheral network, as will be discussed in more detail in the following with reference to FIG. 2.

### Controller-Peripheral Network

FIG. 2 shows an exemplary controller-peripheral network 200. As shown in FIG. 2, the controller-peripheral network 200 includes a controller 210 and a plurality of measurement devices 220. As shown in FIG. 2, the plurality of measurement devices 220 are comprised of the interface 20 described with reference to FIG. 1. Although not shown, the sensor assembly 10 described with reference to FIG. 1 is coupled to each of the plurality of measurement devices 220. As shown in FIG. 2, the plurality of measurement devices 220 include a first through third measurement device 220a-220c.

The controller-peripheral network 200 may be referred to and operate as a master-slave network. With more specificity, the controller 210 of the controller-peripheral network 200 may send commands or requests using a controller-peripheral network protocol to a particular peripheral, such as the first measurement device 220a, on the controller-peripheral network 200. The plurality of measurement devices 220 may not be able to initiate a command or request on the controller-peripheral network 200. A particular peripheral of the plurality of measurement devices 220 may only respond to commands or requests from the controller 210 if the command or request is addressed to the particular peripheral. The controller and the peripherals of the controller-peripheral network may be generally referred to as devices of the controller-peripheral network.

The controller-peripheral network 200 may be a Modbus Remote Terminal Unit (“RTU”) network, although any suitable controller-peripheral network may be employed. In the Modbus RTU network, the controller 210 may be a master that polls the plurality of measurement devices 220, which may be one or more devices configured as slaves on the Modbus RTU network. That is, the controller 210 may send a request over the Modbus RTU network requesting data from a particular peripheral of the plurality of measurement devices 220 on the Modbus RTU network. As discussed above, a slave is unable to provide the data to the Modus RTU network without a request from the master.

Referring to the controller-peripheral network 200 in Modbus RTU terms, the data may be transmitted over the Modbus RTU network using a serial transmission, one bit at a time, as 8-bit bytes. Each slave in the Modbus RTU network may have a unique 8-bit address. The 8-bit address may be referred to as a unit number, although any suitable term may be employed. A packet sent by the master includes the address or unit number of the slave. The packet may include a message intended for the addressed slave. If the slave recognizes the address or unit number, the slave may need to respond within a certain timeframe, or the master will determine that a “no response” error has occurred. When the slave responds to the request from the master a data exchange has occurred.

With more specificity, in the Modbus RTU, each data exchange may be defined as a request from a master to an addressed slave and a corresponding response from the addressed slave. The request and the response may be sent as a packet. Each packet may be viewed as having a pre-defined structure. In the Modbus RTU, the packet may be comprised of a device address, a function code, a register number, a register count, data, and a checksum field. Other formats may be employed in other controller-peripheral networks. The data in the packet may be written and read at registers of a device. The controller-peripheral network's protocol may be used to define how the registers are read and/or written to. The registers may be a 16-bit piece of data. For example, the register may be a signed or unsigned 16-bit integer. Accordingly, for example, if a 32-bit integer value is needed, a pair of 16-bit wide registers can be read. Using Modbus as an exemplary controller-peripheral network, a memory structure of the Modbus registers is described in more detail in the following.

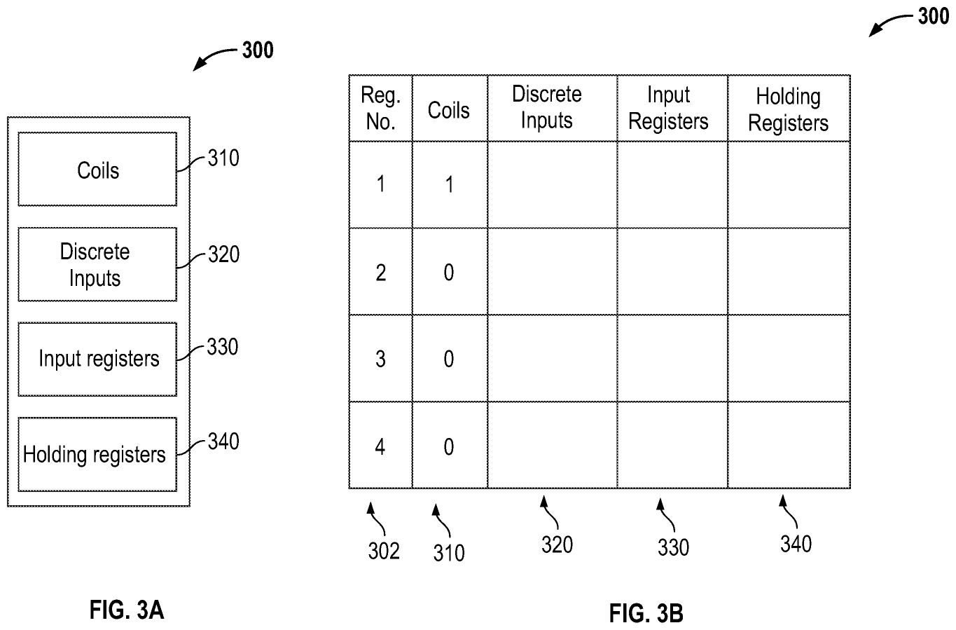

FIGS. 3A and 3B show a memory 300 in single register form (FIG. 3A) and multiple register form (FIG. 3B) for forming a message from a measurement device. As shown in FIG. 3A, the memory 300 is illustrated in the single register form where a single register is comprised of a coil 310, discrete inputs 320, input registers 330, and holding registers 340. Accordingly, FIG. 3A illustrates a structure of a register in the memory 300. FIG. 3B shows how the structure of the register may be populated with data. That is, each register of a plurality of registers in the memory 300 has the structure illustrated in FIG. 3A. The plurality of registers is demarcated by a register number 302 as shown in FIG. 3B. Also shown in FIG. 3B are the coils 310, discrete inputs 320, input registers 330, and holding registers 340.

The coils 310 may be a single bit register that can have a value of “0” or “1”. The coils 310 may be a read and write register. That is, the master may write data to or read data from a coil 310 in the memory 300. The coil 310 may be preferred where a single bit binary value may be sufficient. For example, the master may write a value of “1” to the coil 310 to turn a subcomponent of a device on and write a value of “0” to turn the subcomponent off. In alternative memories, the coil may not be employed where single bit binary values are not useful in a particular device.

Similar to the coil 310, the discrete inputs 320 may also be single bit binary values of “0” or “1”. However, the discrete inputs 320 may be read only. That is, the master may only read a value from the discrete inputs 320 but cannot write a value. Accordingly, a device may provide a power status of the above discussed subcomponent as being “on” if a discrete input 320 value is “1” and a power status as “off” if the discrete input 320 value is “0”. By way of illustration, the master may send a request with a function code to write a value of “1” to the coil 310 that controls whether the subcomponent in the device is turned on and send a subsequent request that reads the discrete input 320 associated with the power status of the subcomponent to determine if the subcomponent is powered up.

The input registers 330 and the holding registers 340 may be more than a single bit long. For example, the input registers 330 and holding registers 340 may be 16-bit long words. The input registers 330 may be similar to the discrete inputs 320 in that they may be read-only. That is, the master may read a value from the input registers 330 but cannot write values to the input registers 330. The holding registers 340 may be read and written to, similar to the coils 310, by the master. As discussed, the packet sent by the master may include a function code. The function code instructs whether a coil 310 or holding register 340 are read or written with data or whether a discrete input 320 or an input register 330 is written to.

With more particularity, the Modbus function code may determine access of the Modbus registers. The following Table 1 illustrates some exemplary function codes.

TABLE 1
Exemplary function codes in a Modbus packet

| Function Code | Register Type |
|---|---|
| 1 | Read Coil |
| 2 | Read Discrete Input |
| 3 | Read Holding Registers |
| 4 | Read Input Registers |
| 5 | Write Single Coil |
| 6 | Write Single Holding Register |
| 15 | Write Multiple Coils |
| 16 | Write Multiple Holding Registers |

As can be appreciated, the function of a register may be to read/write a coil or a holding register or to read from a discrete input or an input register. The registers may be configured and used as needed for a particular application, for example, to uniquely identify a measurement device, such as the measurement devices 220 discussed above, on the controller-peripheral network.

To ensure that the unique identification of the measurement device of the controller-peripheral network correctly identifies the measurement device, the unique identification, as well as other data, such as checksums, may need to be compared to a record that is external to the controller-peripheral network. Such a record may be maintained by the manufacturer of the measurement device or third-party record keeping service. However, relying on such records may require trust. Decentralized networks may provide the record in a manner that does not require trust. An exemplary decentralized network is described in more detail in the following.

### Decentralized Network

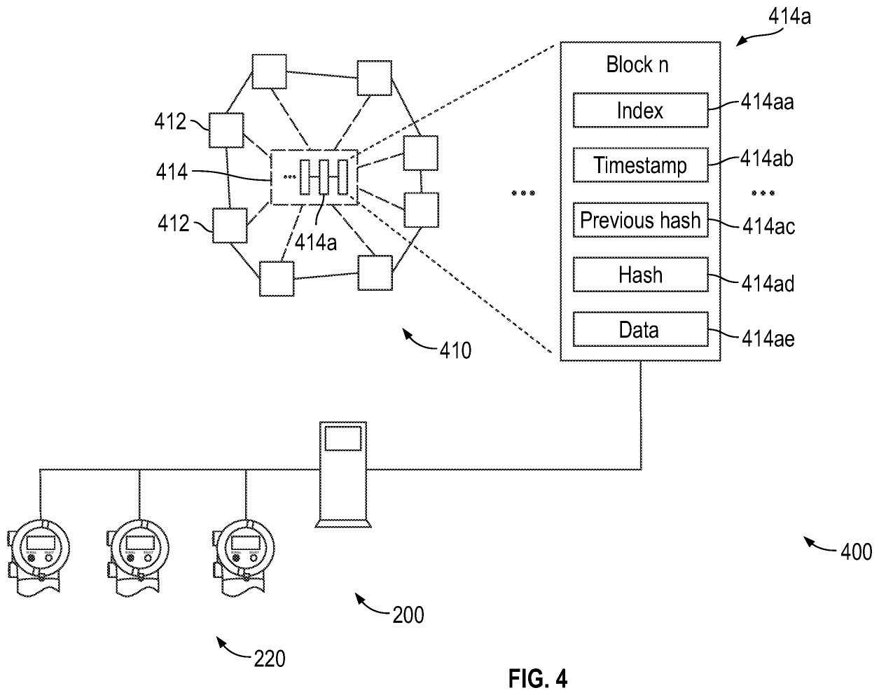

FIG. 4 shows a system 400 including a decentralized network 410. As shown in FIG. 4, the system 400 is comprised of the decentralized network 410 as well as the controller-peripheral network 200 described above. The decentralized network 410 is shown as including a plurality of nodes 412. Although seven nodes 412 are depicted, only two of the nodes 412 are denoted with a reference number for clarity. The decentralized network 410 also includes a blockchain 414. The blockchain 414 is comprised of a plurality of blocks 414a that are linked together with hash values. As an illustration, a most recent block 414a of the blockchain 414 is shown in more detail. The blockchain 414 is stored, updated, maintained, and secured by the nodes 412.

The decentralized network 410 may be a network of computing resources, represented by the nodes 412, that can persistently and immutably store data. For example, a decentralized network may be a blockchain network where a node may stake a position, perform work, or the like, to achieve a network consensus that data should be recorded to an immutable database. Accordingly, as shown in FIG. 4, the decentralized network 410 may be the blockchain network comprised of the nodes 412 that maintains the blockchain 414 as an immutable database where the data in the immutable database is only added by consensus.

The nodes 412 may be any suitable device, server, system, computing resource, or the like that is capable of being a node of the decentralized network 410. The nodes 412 are shown as forming a peer-to-peer ring network although any suitable network topology and protocol may be employed. The nodes 412 may be configured to receive transactions that include one or more references to a prior transaction recorded to the blockchain 414, a transaction to a recipient's address recorded to the blockchain 414, and a signature associated with a sender's address. The transaction may be a ledger entry, or the like, that is pertinent to a flow measurement process. A consensus algorithm may validate the transaction with a majority to all of the nodes 412. After validating the transaction, the transaction may be recorded to a most recent block 414a of the blockchain 414.

For such validation and recordation, the block 414a is shown as including fields comprising an index 414aa, a timestamp 414ab, a previous hash 414ac, a hash 414ad, and data 414ae. The most recent block 414a is shown in block format for clarity, although any suitable representation may be employed. As can be appreciated, all of block 414a in the blockchain 414 may have all of the fields shown in FIG. 4. The index 414aa, timestamp 414ab, previous hash 414ac, and hash 414ad may be used to validate and secure the data 414ae, as will be described in more detail in the following.

The index 414aa may be a sequential value that indicates a sequential order of the block 414a in the blockchain 414. For example, the index 414aa may be equal to the value “n” of the block 414a shown in FIG. 4, although any suitable value may be used. Similarly, the timestamp 414ab may be a value that indicates the time that block 414a was added to the blockchain 414, although any suitable timestamp may be employed. Values of the index 414aa and the timestamp 414ab may be determined by the nodes 412 using the validation algorithm.

The previous hash 414ac may be the hash 414ad of the block immediately preceding the most recent block 414a. The hash 414ad may be hash of various values, such as the index, data, etc., in the most recent block 414a. The hash 414ad of the most recent block 414a may be recorded in an immediately subsequent block 414a as the previous hash 414ac. Accordingly, the block 414a of the blockchain 414 may be sequential. The sequential order of the block 414a may be verified by determining a hash value of the other fields of a given block 414a and comparing the determined hash value with the previous hash 414ac of the block 414a immediately subsequent to the given block 414a. These and other methods may be used to verify that the values of the fields in the block 414a of the blockchain 414 have not been altered, thereby ensuring the integrity of the data 414ae. Accordingly, the data 414ae may be viewed as a permanent and unalterable recordation.

As is described above, data (e.g., message, transaction, etc.) may be recorded to the blockchain 414. The data may be signed by a private key of a public key-private key pair. For example, a one-way algorithm (e.g., Elliptic Curve Digital Signature Algorithm) may generate a value using a message and the private key. The value that results from the message and the signature may be a signature. The ownership of the private key can be verified by using the public key of the private key used to sign the message. The message may also be verified with the original message and the public key or associated address. Accordingly, for example, the owner of the private key and the message can be verified (e.g., proof that a private key was used to sign a transaction) without revealing the signatory's private key or any seeds that may have been employed to generate the private and public key pair.

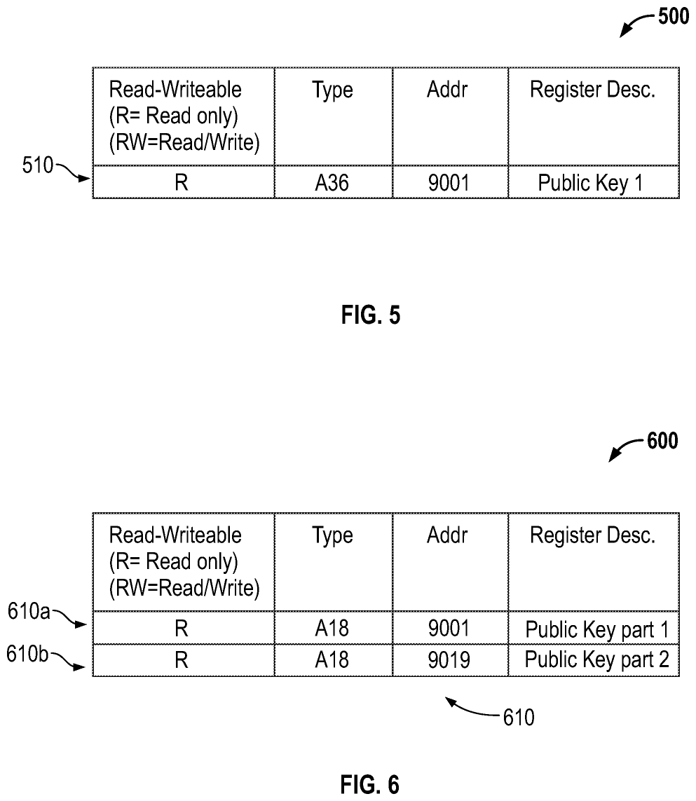

A peripheral device, such as one of the measurement devices 220, may be uniquely identified by employing a public and private key pair. More specifically, a public key and a private key may be generated when, for example, a transaction is initiated by the manufacturer of measurement device 5. Such a configuration is discussed in more detail in the following with reference to FIG. 5.

### Uniquely Identified Measurement Device

FIGS. 5 and 6 show an undivided unique identification register 500 and a divided unique identification register 600. As can be seen, the undivided unique identification register 500 and the divided unique identification register 600 include read-writeable, type, address, and register description columns. As shown in FIG. 5, the undivided unique identification register 500 is comprised of a public key register 510. The public key register 510 is read only and is type A36. Although the public key register 510 is read only, the public key register 510 may be written to by the manufacturer. The public key register 510 has an address of 9001. A private key paired with the public key may be stored in, for example, a secured storage of a measurement device.

With reference to FIG. 6, the divided unique identification register 600 is comprised of a first public key register 610a and a second public key register 610b. A private key row is not shown for clarity. Similar to the public key register 510, the first public key register 610a and the second public key register 610b are read only but may be rewritable by the manufacturer. However, the first public key register 610a and the second public key register 610b types are A18. That is, the first public key register 610a and the second public key register 610b cannot hold as many bits as the public key register 510. Accordingly, a public key may not be stored in a single register and may need to be split across two registers. Therefore, the first public key register 610a and the second public key register 610b are respectively labeled “Public Key part 1” and “Public Key part 2”.

As discussed above, a private key and a public key may be paired. With more specificity, a private key is generated by, for example, a manufacturer of a measurement device, such as the measurement device 220, and the public key is generated with a one-way encryption algorithm from the private key. The private key may be generated based on values in a seed, such as a series of random words, numbers, or the like. A one-way encryption algorithm (e.g., elliptic curve multiplication) may generate the public key pair from the private key. The seed and the private key are kept secret whereas the public key may be shared. The manufacturer may store the private key in a secured memory of the measurement device that is not available to parties other than the manufacturer, or elsewhere, such as a gateway managed by the manufacturer, and retain the seed. The public key may be used to generate a blockchain address so that transactions including the blockchain address may be recorded to a most recent block 414a of the decentralized network 410. The private key may be used to sign any transactions that are recorded to the decentralized network 410. More specifically, a hash value may be generated as an input to a transaction to show that the measurement device 220 has the private key.

Other unique identifications can be used. For example, token identifiers may be used. Token identifiers may be generated based on a file provided by, for example, a manufacturer of the measurement device 220. By way of illustration, values from, for example, read-only registers of the measurement device 220 may be obtained and placed in a file. This file may be hosted on a file server that has a link to the file. The file link may be generated based on the contents of the file. An example is a content identifier (“CID”) that is generated by a decentralized file hosting service, such as the InterPlanetary File System (“IPFS”), from the contents of the file. The file link may be recorded as metadata in a token generation file, such as a JavaScript Object Notation (“JSON”) file that can be used by a token generator to generate a non-fungible token, such as an Ethereum Request for Comments 721 (“ERC721”) or ERC20 compliant token. The token generator may then accordingly generate a token identifier of the measurement device 220. As can be appreciated, the token identifier is unique in that the same token identifier cannot again be generated. Additionally, where a CID is employed, the file stored at the file link cannot be modified. In contrast to the seed discussed above, the file that is used to generate the token does not need to be kept secret.

Additionally, or alternatively, other registers may be employed depending on the type of unique identification employed. For example, registers of type A242 in the Modbus protocol may hold any data, bounded by a number of bits. Accordingly, registers of type A242 may be suitable for storage/use of cryptographic tokens, as well as any other unique identifications that may need such data type.

In the above and other methods, a unique identification of the measurement device 220 can be generated and stored in the decentralized network 410 such that trust is not an issue. By way of illustration, a signature of a transaction signed by the measurement device 220 can be verified as being paired with a public key of the measurement device 220. Additionally, in another example, where a token identifier is used, the values of the input registers in the measurement device 220 can be verified as being the same as values recorded in a file at a file link of the token identifier. Accordingly, stakeholders and non-stakeholders may, without incurring risks associated with trust, determine that data recorded to the decentralized network 410 is actually associated with the measurement device 220 identified by the unique identification.

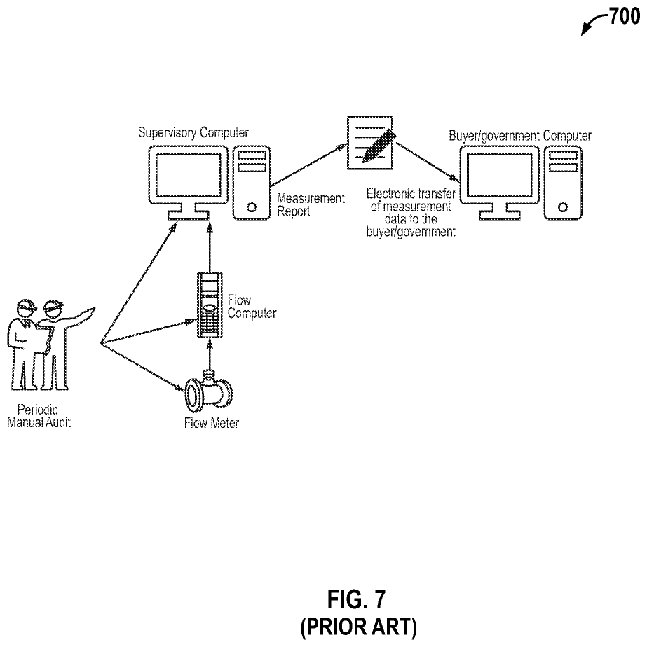

As discussed above, there may be several stakeholders involved in the transfer of fluids, such as hydrocarbons. The stakeholders may include contracting parties such as the buyer, seller, shore facilities, shipping, etc. and regulatory authorities, such as states or national governments. Trust may be involved when the stakeholders share information that can verify that a measurement is correct. Trust may be a key concern because the technical details involved with ensuring the integrity of measurement data may be difficult for various reasons. For example, measurement systems that include measurement devices, such as fluid metering systems, may be subject to various conditions that effect the uncertainty associated with the data they present, including calibration and maintenance schedules, unstable process conditions, flow restrictions and human error, as is explained in more detail in the following with reference to FIG. 7.

### Typical Measurement System

FIG. 7 shows a typical measurement system 700. As shown in FIG. 7, the measurement system 700 includes a flow meter that is communicatively coupled to a flow computer, which is communicatively coupled to a supervisory computer. The supervisory computer is communicatively coupled to buyer/government computer. The supervisory computer is shown as being configured to convey a measurement report to the buyer/government computer. Accordingly, the supervisory computer may provide for an electronic transfer of measurement data to the buyer/government computer.

The flow meter, flow computer, and supervisory computer may be owned by a seller of the fluid measured by the flow meter. For example, the seller may provide the measurement report to the buyer/government computer after a custody transfer of a fluid from the seller to the buyer. The buyer/government computer may be owned by the buyer or government that may have an interest in the transfer of a fluid measured by the flow meter. Accordingly, the seller, buyer, and/or government may be viewed as stakeholders in the custody transfer of a fluid and, thus, stakeholders in accurate measurement data of the fluid transfer.

The flow meter may be any suitable meter, such as a volumetric and/or mass flow rate meter. The flow meter may provide signals representative of fluid properties of a fluid sensed by the flow meter. The flow meter can provide raw signals, fluid property values, such as uncorrected fluid property values, or the like, to the flow computer. The flow computer may receive the signals from the flow meter representative of fluid properties measured by the flow meter. The flow computer can calculate fluid property values based on the received signals. For example, the flow computer may be an exemplary volume conversion device configured to adjust values from the flow meter depending on process conditions such as temperature and pressure, and produces figures for gross, standard, mass and energy flow rates and totals. Accordingly, although not shown for clarity, the measurement system 700 may also be communicatively coupled with other ancillary devices, including temperature and/or pressure transmitters/transducers, gas chromatographs, and/or densitometers.

The supervisory computer may collate information from the flow computer, as well as other flow computers, and produce measurement reports. The measurement reports may include information related to the flow meter, as well other flow meters, measured values obtained from the flow meters, and/or any other suitable values. As can be appreciated, additional electronic systems may be present to analyze and detect faults in the devices, and these systems may add a degree of integrity checking for the system.

To ensure the integrity of measurement data, manual audits of metering systems are still widespread but suffer from several challenging issues. For example, metering systems are often found in dangerous and challenging environments. There are health and safety considerations alongside logistical concerns with sending auditors to sites. Furthermore, between audits, a stakeholder may not have confidence that the seller is maintaining their portion, such as the flow meter, the flow computer, and/or the supervisory computer, of the measurement system 700. Additionally, an auditor is required to trust that the data recorded for auditing purposes is accurate.

All the devices, their calibration records and maintenance records may need to be checked during an audit. While electronic records may exist, they may necessarily reside in the seller's portion of the measurement system 700. Again, this may require that another stakeholder and/or auditor trust the seller's maintenance of the electronics records. One potential remedy is for the buyer to duplicate the entire measurement system as a means of independently cross-checking the figures and ensuring the integrity of the data. Obviously, this entails huge expense, both capital and ongoing operational costs, with disputes being difficult to resolve if no obvious source of error is detected.

As suggested above, the issue of trust, as well as expenses associated with duplicating the entire measurement system 700, may be avoided by employing a decentralized network, such as the decentralized network 410 described with reference to FIG. 4. That is, the decentralized network may replace an audit trail and ensure data reliability. However, this assumes that the data provided by the seller is correct. Accordingly, a gateway to the decentralized network may ensure that the data recorded to the decentralized network may be correct.

### Decentralized Network Gateway

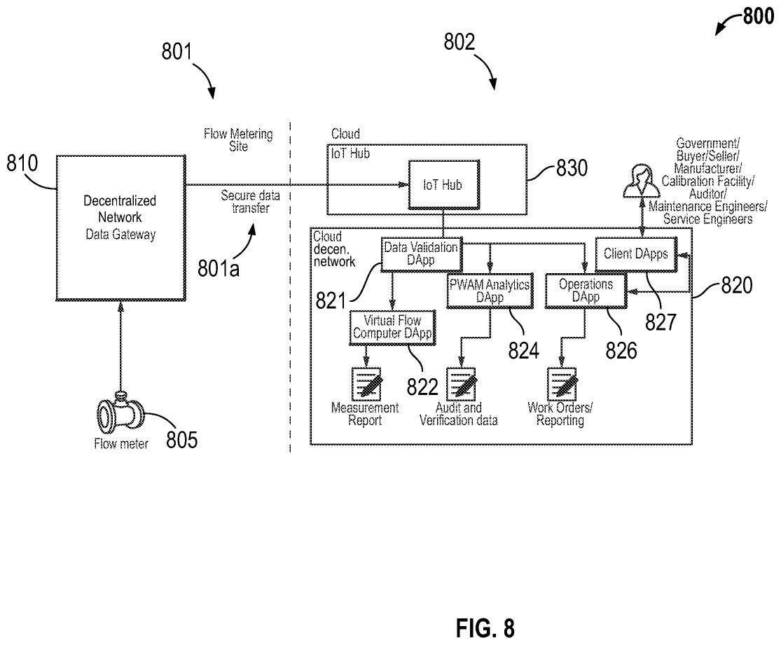

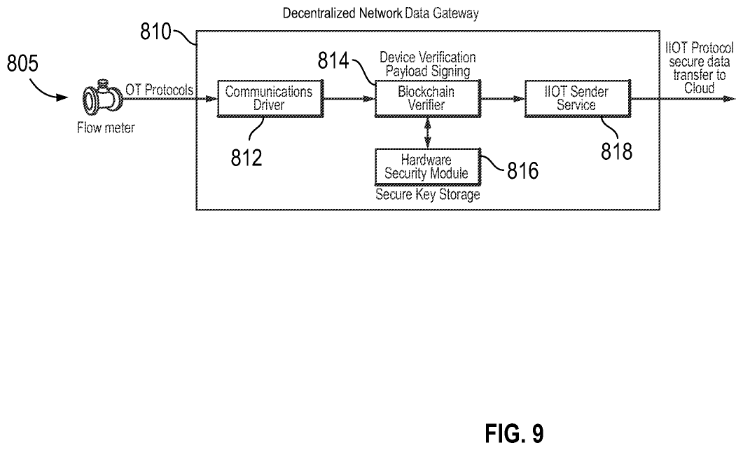

FIG. 8 shows a block diagram of a decentralized network measurement system 800 configured for data validation of a message from a measurement device 805. As shown in FIG. 8, the decentralized network measurement system 800 is comprised of flow measuring site 801 that is communicatively coupled to a cloud service 802 via a secure data transfer 801a. The flow measuring site 801 is comprised of a measurement device 805 that is communicatively coupled with a decentralized network data gateway 810. The cloud service 802 is shown as being comprised of a cloud decentralized network 820 that is communicatively coupled with a IoT hub 830. As shown in FIG. 8, the decentralized network data gateway 810 is communicatively coupled to the cloud decentralized network 820 via the IoT hub 830. The decentralized network data gateway 810 will be described in more detail with reference to FIG. 9.

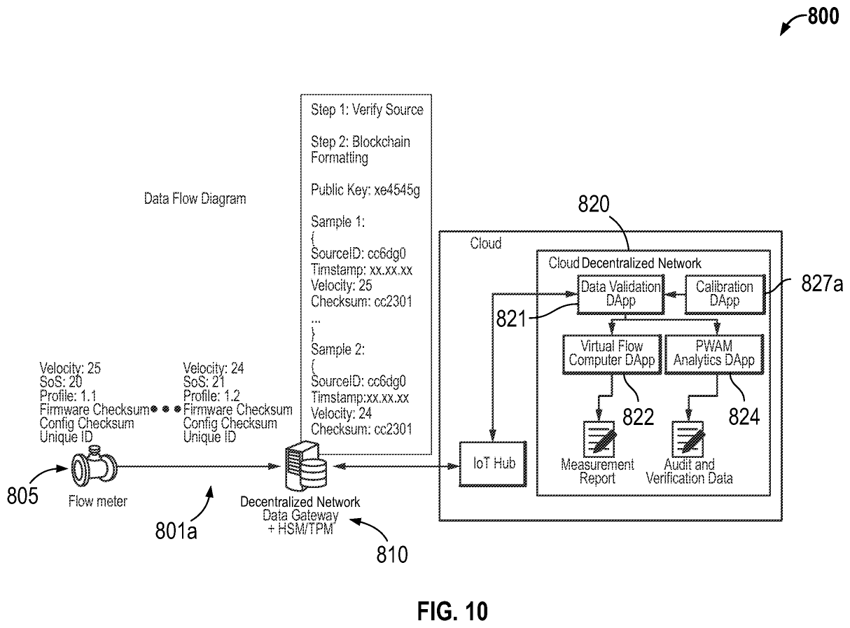

Still referring to FIG. 8, the cloud decentralized network 820 is shown as being comprised of a data validation distributed application (“DApp”) 821 that is communicatively coupled to a virtual flow computer DApp 822, an analytics DApp 824, and an operations DApp 826. The operations DApp 826 is communicatively coupled with client DApps 827. Although not shown in FIG. 8, as will be described in more detail in the following with reference to FIG. 10, the cloud decentralized network 820 may include a calibration DApp communicatively coupled to the data validation DApp 821. The data validation DApp 821 may check the measurement device 805 using the calibration DApp to show that the measurement device 805 has been calibrated in accordance with the regulatory requirements.

As will be explained in more detail in the following, the measurement device 805 and/or the decentralized network data gateway 810 may be configured to provide, obtain, and/or process three types of data in one or more messages to form or validate a message: measurement data, validation data, and integrity data. Measurement data may be the process values used in a measurement system for the reporting of fluid transfer. Measurement data is provided by the measurement device 805. Validation data may be one or more parameters that can be used to uniquely identify the measurement device 805 and to validate the measurement device 805 against a whitelist, such as an identity whitelist. Validation data could come from the measurement device 805 or compiled by the decentralized network data gateway 810. Integrity data may be one or more parameters that can be used to validate that the measurement device 805 configuration is in accordance with the approved configuration for the specific measurement device 805. The integrity data could come from the measurement device 805 or compiled by the decentralized network data gateway 810.

The measurement device 805 is shown as a generic flow meter, although any suitable measurement device may be employed. The measurement device 805 may be one of the measurement devices 220 described above with reference to FIGS. 2 and 4. With reference to FIG. 8, the measurement device 805 may provide data to the decentralized network data gateway 810. For example, the measurement device 805 may provide measurement data, checksums, firmware data, a unique ID, configuration information, and/or the like. The data may be provided in accordance with any suitable protocol. For example, the data may be provided in messages, such as the Modbus RTU packets described above. The messages may be encapsulated into other protocols, such as Message Queuing Telemetry Transport (“MQTT”), Advanced Message Queuing Protocol (“AMQP”), HyperText Transfer Protocol (“HTTP”), Bluetooth, or the like.

Exemplary measurement data may be any suitable measurement of a physical property, such as density, flow rate, or the like. The checksums may be any suitable value that can be used to check a value of a register in a measurement device, such as the measurement device 805. For example, a cyclical redundancy check (“CRC”) may be performed on a value in a register of the measurement device 805. The unique identification may be a public key, a serial number provided by a manufacturer of the measurement device, and/or one or more values in read-only registers (e.g., Modbus input registers) of the measurement device 805. The combination of these values may be a unique identification of the measurement device 805.

Additionally, or alternatively, the decentralized network data gateway 810 can create a unique identification for the measurement device 805 and store the unique identification in the measurement device 805 or the decentralized network data gateway 810. For example, the decentralized network data gateway 810 may obtain a public key from the cloud decentralized network 820 and associate a read-only register value, such as a serial number, combination of register values, and/or the like, of the measurement device 805 with the public key. Some exemplary read-only registers of the measurement device 805 may be a central processing unit (“CPU”) board serial number, a revision number of a board, such as a field programmable gate array (“FPGA”), data acquisition board, or the like, board. The association between the public key and the read-only register value(s) may be stored in the hardware security module 816 of the decentralized network data gateway 810.

The decentralized network data gateway 810 receives the data from the measurement device 805 and verifies that the data is sent by the measurement device 805. For example, the decentralized network data gateway 810 may recalculate checksums from the provided data. Additionally, or alternatively, the decentralized network data gateway 810 may receive checksums from the measurement device 805. The checksums of the measurement device 805 may be compared against an approved set, such as an integrity whitelist, for the measurement device 805. By way of illustration, the decentralized network data gateway 810 may verify that the firmware checksum provided by the measurement device 805 is the same as an expected firmware checksum. These and other details are described in the following with reference to FIG. 9.

With reference to FIG. 8, the data validation DApp 821 may validate the data provided by the measurement device 805. For example, the data validation DApp 821 may maintain a secure storage of device, stakeholder, and non-stakeholder's unique identifications (e.g., public keys, addresses, etc.) that are permitted to send data to the cloud decentralized network 820. The secure storage of the device, stakeholder, and non-stakeholder's unique identifications may serve as an identification whitelist. As will be described in the following with reference to FIG. 10, the data validation DApp 821 may interact with the decentralized network data gateway 810 to ensure only whitelisted measurement devices can communicate with the cloud decentralized network 820.

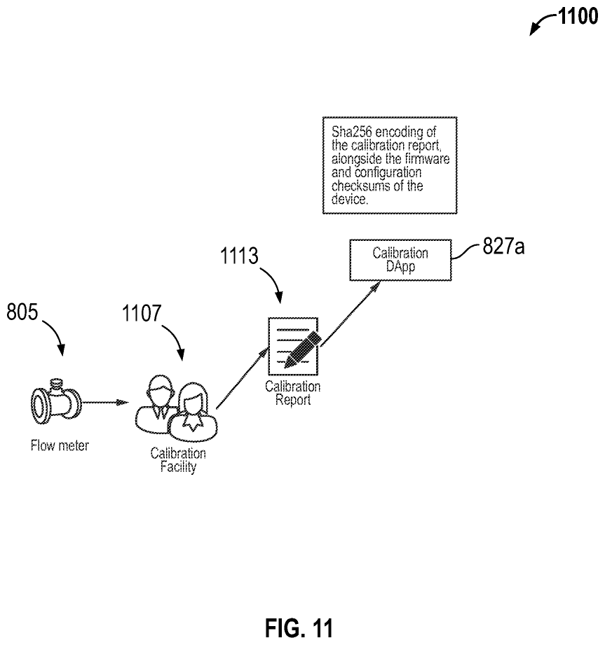

The data validation DApp 821 may also check that the measurement device 805 has been calibrated by cross-checking the device's unique identification with, for example, a calibration DApp, which is described in more detail with reference to FIG. 11. Similarly, the data validation DApp 821 may check that the measurement device 805 has been maintained by cross-checking the unique identification of the measurement device 805 with a maintenance DApp. The data validation DApp 821 may also check that service visits have been conducted by approved organizations with a service DApp.

Should any of the above checks fail, the application can raise an alert to relevant stakeholders on the cloud decentralized network 820, logging the discrepancy in a dedicated audit trail data store. Any reports produced using data that has failed a check could be watermarked as provisional. The stakeholders could be notified of any remedial action via the stakeholders' DApp interfaces and may be, for example, required to sign these changes as approved before the associated data is marked as final. This may include a more detailed mismeasurement process, which could be facilitated by the software running on the analytics DApp 824, or elsewhere.

The virtual flow computer DApp 822 performs any suitable calculations similar to or the same as those performed by the flow computer described above with reference to FIG. 7. For example, the virtual flow computer DApp 822 may calculate fluid property values based on the data provided by the data validation DApp 821. For example, the virtual flow computer DApp 822 may be an exemplary volume conversion device configured to adjust values from the measurement device 805 depending on process conditions such as temperature and pressure, and produces figures for gross, standard, mass and energy flow rates and totals. However, as can be appreciated from FIG. 8, the virtual flow computer DApp 822 is a DApp and therefore any calculations may be performed as part of the cloud decentralized network 820. Accordingly, the calculations may be recorded to a blockchain.

The analytics DApp 824 may be a remote monitoring and analytics platform that ensures the performance of a customer's metering equipment. For example, the analytics DApp 824 could form part of an audit chain. For example, the analytics DApp 824 can verify the data provided by the measurement device 805 via the data validation DApp 821. By way of illustration, the analytics DApp 824 may be a series of analytics routines for each device where, for example, an ultrasonic meter can be verified by checking a speed-of-sound (“SOS”) against a separate device that resides on site (e.g., a gas chromatograph) as well as tracking key performance indicators (e.g., a profile factor, turbulence, symmetry, or the like) against a stored and know-good benchmark over time. Such comparisons may include uncertainty values which can also be recorded to the blockchain using a signature of the gas chromatograph and/or decentralized network data gateway 810. The analytics modules may be for a wide array of devices on the decentralized network measurement system 800.

Accordingly, the client DApps 827 may obtain information from the operations DApp 826 and, optionally, perform actions based on the information. For example, the client DApps 827 may be an approval process where an unauthorized change to the measurement device 805 is approved by a regulatory authority after reviewing the information related to the measurement device 805. Such an approval may, for example, remove a provisional status of the data that is provided by the measurement device 805. Such data may then be included in, for example, a measurement report provided by the virtual flow computer DApp 822. Other client DApps may be employed.

As can be appreciated, various DApps may be employed to execute decentralized (i.e., trustless) functions based on the data that is provided by the measurement device 805. However, such decentralized functions may necessarily rely on the integrity of the data provided by the measurement device 805. Accordingly, the decentralized network data gateway 810 may obtain from the cloud decentralized network 820 information needed to function as an identity whitelist and an integrity whitelist for the decentralized network measurement system 800, as will be described in more detail in the following.

### Decentralized Network Data Gateway

FIG. 9 shows a detailed view of the decentralized network data gateway 810. As shown in FIG. 9, the decentralized network data gateway 810 receives data from the measurement device 805, although the decentralized network data gateway 810 may also be configured to receive data from other measurement devices. As shown in FIG. 9, the decentralized network data gateway 810 includes a communications driver 812 that is communicatively coupled to the measurement device 805. The communications driver 812 is also communicatively coupled to a blockchain verifier 814. The blockchain verifier 814 is communicatively coupled to a hardware security module 816 and an industrial internet of things (“IIoT”) sender service 818. The IIoT sender service 818 is shown as providing a IIoT protocol data to a cloud service.

The communications driver 812 may be any suitable communications driver that can communicate with one or more measurement devices, such as the measurement device 805. For example, the communications driver 812 may be software that supports the industrial communications protocols that can communicate with measurement devices on the measurement system. Examples of industrial communications protocols include Modbus, Open Platform Communications (“OPC”) and Highway Addressable Remote Transducer (“HART”), although any suitable communications protocol may be employed.

The blockchain verifier 814 may be any suitable circuit, algorithm, processor, and/or the like, that can verify that a source of the data provided to the communications driver 812 is a trusted source. For example, the blockchain verifier 814 may be an algorithm that is used to verify that the measurement device 805 may be trusted and can be permitted to send data to the cloud. With more particularity, the blockchain verifier 814 may determine that the measurement device 805 is an actual provider of the data and that the data can be sent to the cloud decentralized network 820 described above.

The hardware security module 816 may be any suitable circuit, software, processor, and/or the like, that can securely store one or more private keys of the decentralized network data gateway 810. For example, the hardware security module 816 may be an algorithm that securely stores a private key of the decentralized network data gateway 810. By way of illustration, a Trusted Platform Module or other secure storage technology could be used. A private key of the decentralized network data gateway 810 can be used to sign data being sent to the cloud service, such as the cloud decentralized network 820 described above.

The IIoT sender service 818 may be any suitable circuit, algorithm, processor, and/or the like, that can support communications protocols to send the data to the cloud. For example, as shown in FIG. 9, the IIoT sender service 818 may be software that supports the IoT protocols for sending data to the cloud service. Examples of IoT protocols include MQTT and AMQP. As discussed above, the cloud service may be the cloud decentralized network 820. The decentralized network data gateway 810 may be configured to perform various steps to ensure the integrity of the data provided to the cloud decentralized network 820.

To ensure integrity of the data provided by the measurement device 805, the decentralized network data gateway 810 can read the checksums from the measurement device 805 using, for example, an American Standard Code for Information Interchange (“ASCII”) representation for sending across, for example, a Modbus network. Where a measurement device providing data to the decentralized network data gateway 810 does not include or is unable to provide a checksum to the decentralized network data gateway 810, the decentralized network data gateway 810 may be configured to calculate the checksums by implementing an encryption algorithm across the read-only and/or read-writeable parameters of the device and storing this via the data validation DApp 821 in the cloud decentralized network 820.

The read-only parameters may be writeable by the manufacturer of the device but not by other parties. The read-writeable parameters may be those that can be read or written by those with access, via a communications port for example, to the read-writeable parameters. Accordingly, for example, if the device does not store a firmware checksum, but does store something like firmware revision numbers of board serial numbers of a board in the device, these firmware revision numbers could be read and combined by the decentralized network data gateway 810 into a checksum.

The decentralized network data gateway 810 and the data validation DApp 821 may be configured to perform the following steps. First, the decentralized network data gateway 810 may communicate with the data validation DApp 821 to obtain the latest whitelist. For example, the decentralized network data gateway 810 may periodically, contingently, such as when events occur, or the like, obtain the whitelist. Additionally, or alternatively, the data validation DApp 821 may provide the whitelist in response to a request from the decentralized network data gateway 810. The measurement device 805 could be verified against the whitelist. Accordingly, the data validation DApp 821 could check previous messages sent between downloads of the whitelist and take any required action for any discrepancies found.

Second, after the measurement device 805 has been verified, the decentralized network data gateway 810 can format the message in an IoT message format supported by the cloud decentralized network 820. Such formatting may include adding checksums, batching the data, and/or the like. Adding the checksums may be required where the measurement device 805 did not provide the checksums. Batching of the data may be advantageous or necessary by, for example, minimizing data transfer to the cloud decentralized network 820.

Third, the data may be signed. For example, a signature may be obtained from the hardware security module 816 and used to sign the data to be provided to the cloud decentralized network 820. The signature may allow the data validation DApp 821 to verify that the data is provided by the decentralized network data gateway 810.

Fourth, an operational integrity of the measurement device 805 can be verified. For example, the data validation DApp 821 may compare the unique identification of the data with unique identifications of any maintenance, calibration, and service records. By way of illustration, maintenance records may be indexed by the unique identification values. Accordingly, the data validation DApp 821 may perform an algorithm that checks that the measurement device 805 is not overdue for a scheduled maintenance. In one embodiment, the cloud decentralized network 820 may store a “good until” date associated with the most recent scheduled maintenance. If a date of the data provided by the measurement device 805 is less than the “good until” date, then the data may be indicated as being from the maintained measurement device 805.

Fifth, measurement values may be calculated. For example, in a custody transfer of hydrocarbons, the measurement data may be summed to arrive at a total value. The calculation of the measurement values may be performed by the virtual flow computer DApp 822. Accordingly, the virtual flow computer DApp 822 may accumulate the data provided by the measurement device 805 and validated by the data validation DApp 821 until the custody transfer is complete. Additionally, or alternatively, the virtual flow computer DApp 822 may calculate measurement values that are contemporaneous of the measurement data of the data provided by the measurement device 805. By way of illustration, a mass flow rate value may be calculated using a volume flow rate multiplied by a density of the fluid.

Sixth, the cloud decentralized network 820 may produce reports. For example, with reference to FIG. 8, the virtual flow computer DApp 822 may produce a measurement report that contains the measurement values determined by the virtual flow computer DApp 822. Similarly, the analytics DApp 824 may produce an audit and verification data report and the operations DApp 826 may produce a work order report. The reports may be produced, for example, periodically, on request, and/or the like.

In addition to physical devices, such as the measurement device 805 described with reference to FIGS. 8 and 9, the cloud decentralized network 820 may be configured to be used by third parties or non-stakeholders. For example, third parties may ensure an integrity of the measurement report provided by the virtual flow computer DApp 822. As an example, an independent calibration facility where flow meters are sent for periodic re-calibration may be able to add calibration data to the cloud decentralized network 820, as will be described in more detail in the following.

### Exemplary Calibration Facility Acting as a Non-Stakeholder

FIG. 10. shows a flow diagram view of the decentralized network measurement system 800. As shown in FIG. 10, the decentralized network measurement system 800 is comprised of the measurement device 805 coupled to the decentralized network data gateway 810 via the secure data transfer 801a. The decentralized network data gateway 810 is communicatively coupled to the cloud decentralized network 820. As shown in FIG. 10, the cloud decentralized network 820 is depicted in an alternative detailed view. With more particularity, the cloud decentralized network 820 is shown as including the data validation DApp 821, the virtual flow computer DApp 822, and the analytics DApp 824, which are communicatively coupled to each other. However, the client DApps 827 described with reference to FIG. 8 is shown as an exemplary calibration DApp 827a.

As can be seen in FIG. 10, the measurement device 805 provides data having various data fields to the decentralized network data gateway 810. With more particularity, the measurement device 805 provides measurement data comprising a velocity, SOS, and a profile. Additionally, the measurement device 805 provides a unique identification, which may be any suitable unique identification, such as those described above. The measurement device 805 also provides checksums comprising a firmware checksum and a configuration checksum.

FIG. 10 also shows an exemplary processing performed by the decentralized network data gateway 810. With more particularity, as shown in FIG. 10, the decentralized network data gateway 810 verifies the source and performs blockchain formatting, which may in general be referred to as decentralized network formatting. In the example shown in FIG. 10, the decentralized network data gateway 810 can verify the source by obtaining a firmware and configuration information associated with the unique identification of the data provided by the measurement device 805. Additionally, or alternatively, other data may be obtained.

As shown in FIG. 10, the unique identification and the firmware checksums and configuration checksums may be used to verify that the measurement device 805 is authorized to send the measurement data to the cloud decentralized network 820. For example, during initial installation the decentralized network data gateway 810 can read the firmware and configuration checksums from the measurement device 805, or any other devices, of the decentralized network measurement system 800. An auditor/approval/regulatory body representative could digitally sign these checksums using their client DApps 827 (e.g., on site, remotely, etc.). These approved checksums would be stored by the decentralized network data gateway 810, either locally and/or to the storage service (e.g., IPFS), using the unique identification of the measurement device 805 as an index.

When the decentralized network data gateway 810 receives data from the measurement device 805, or periodically, the decentralized network data gateway 810 may first verify the unique identification of the measurement device 805 against the whitelist, which may be locally or remotely stored. If the measurement device 805 passes the whitelist check, the decentralized network data gateway 810 could then verify the checksums provided by the measurement device 805 as shown in FIG. 8 against the stored, approved versions to ensure nothing in the measurement device 805 has changed. Where a change was detected, the decentralized network data gateway 810 could raise an alert to inform all the relevant stakeholders that something had been changed on the measurement device 805 without authorization. An approval body could be given the option of approving the change using their client DApps 827, otherwise the data would be marked as unapproved, and any reports would have a visible indication of this, such as a watermark, stamp, data field, or the like.

Additionally, to avoid such issues, where an operator wished to change a parameter or firmware on the measurement device 805, the operator may first use their client DApps 827 to propose the change, and the other stakeholders could then approve the proposed change using their client DApps 827. The decentralized network data gateway 810 could then accept updated checksums from the measurement device 805, and store these as an updated and approved set. As can be appreciated, the decentralized network data gateway 810 can be employed in other processes, such as a calibration process, to ensure the integrity of the data provided by the measurement device 805.

FIG. 11 shows a data flow 1100 of a calibration report according to the detailed view of the cloud decentralized network 820. As shown in FIG. 11, the data flow 1100 includes the measurement device 805 that provides data to a calibration facility 1107. The calibration facility 1107 is shown as providing a calibration report 1113. Although not shown in FIG. 11, the calibration report 1113 may be provided to the cloud decentralized network 820 described with reference to FIG. 8. As shown in FIG. 11, the calibration report 1113 is provided to the calibration DApp 827a.

A calibration technician may calibrate the measurement device 805 using the calibration facility 1107. Once the measurement device 805 has been calibrated the calibration technician can use the services provided by the cloud decentralized network 820. For example, as shown in FIG. 11, the calibration DApp 827a can be used to read a quick response (QR) code on the measurement device 805 that holds a representation of a unique identification (e.g., public key, serial number) and other relevant details of the measurement device 805. The calibration technician can attach the calibration report 1113 to a data packet and, using the calibration DApp 827a and a private key of the calibration technician and/or the calibration facility 1107, submit the calibration report 1113 to the cloud decentralized network 820. The data validation DApp 821 of the cloud decentralized network 820 may check the data packet using a public key of the calibration facility 1107 after checking that the public key is whitelisted. Once verified, the data packet may be stored on the cloud decentralized network 820.

### Methods

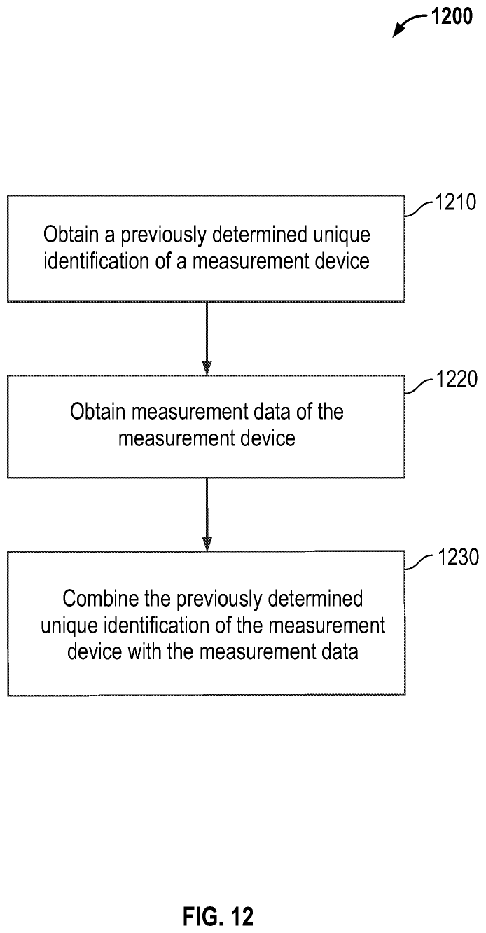

FIG. 12 shows a method 1200 for forming a message from a measurement device for data validation. As shown in FIG. 12, the method 1200 begins by obtaining a previously determined unique identification of a measurement device in step 1210. In step 1220, the method 1200 obtains measurement data of the measurement device. The method 1200, in step 1230, combines the previously determined unique identification of the measurement device with the measurement data. The method 1200 may be configured to perform other steps.

For example, obtaining the previously determined unique identification of the measurement device may comprise reading the previously determined unique identification from one or more registers of the measurement device. The previously determined unique identification of the measurement device may be one of a public key obtained from a decentralized network and a serial number obtained from the measurement device. The serial number of the measurement device may be previously associated with the public key.

Additionally, or alternatively, the method 1200 may further comprise obtaining a checksum of the measurement device and combining the checksum with the previously determined unique identification of the measurement device. The checksum may comprise one of a firmware checksum and a configuration checksum of the measurement device. The method 1200 may further comprise securing the message for transmission over a secure channel to a cloud decentralized network. For example, securing the message for transmission comprises securing the message for transmission to an internet-of-things hub communicatively coupled to the cloud decentralized network.

The unique identification and the measurement data may be obtained from the measurement device via a single message or separate messages. That is, a first message that contains the unique identification may be provided by the measurement device and a second message, sequential or non-sequential to the first message, containing the measurement data may be provided by the measurement device. The message from the measurement device may therefore be formed, for example, where the separate messages are utilized, in a decentralized network data gateway. Alternatively, the message from the measurement device may be formed in the measurement device. Accordingly, the unique identification of the measurement device and the measurement data may be provided by the measurement device in a single message.

In a Modbus network, for example, the method 1200 could have the following steps.
1) A decentralized network data gateway requests measurement data in one or more polls (groups of registers).
2) The decentralized network data gateway requests validation data in one or more polls.
3) The decentralized network data gateway checks the validation data against the whitelist.
4) The decentralized network data gateway reformats the messages since the most recent validation, marking them as valid/invalid and reformatting them in a consolidated message that the decentralized network data gateway signs with its own private key for onwards processing as described later.

In practice, the interval between requesting the measurement data and the validation data may be so short that it would be difficult to spoof. There could also be, perhaps preferably, a mechanism whereby, if the measurement device went offline before the measurement data was validated, the decentralized network data gateway would then either hold that measurement data until the measurement device was back online and could be verified or mark the measurement data as unvalidated and send it onwards.

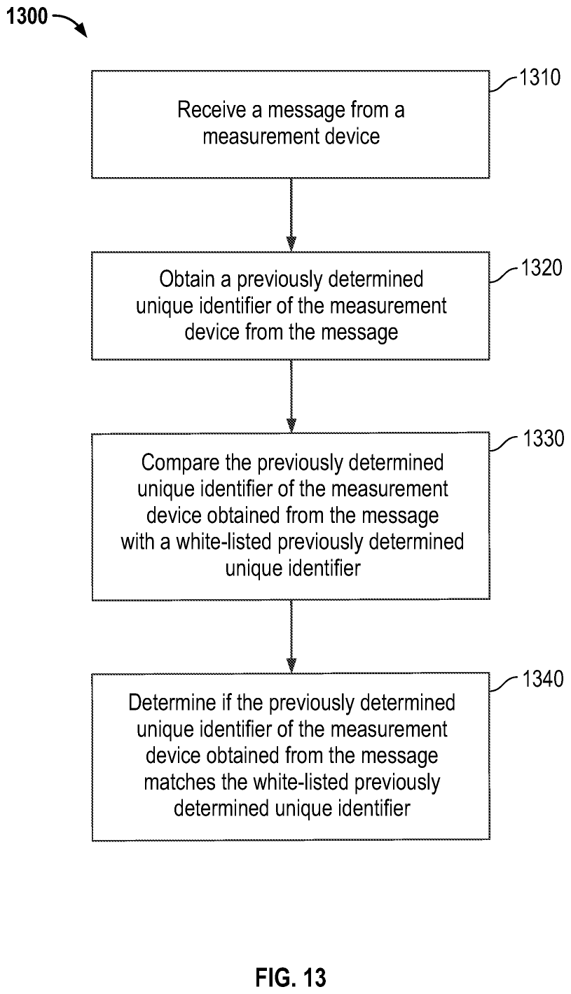

FIG. 13 shows a method 1300 for data validation of a message from a measurement device. As shown in FIG. 13, the method 1300 receives a message from a measurement device in step 1310. In step 1320, the method 1300 obtains a previously determined unique identification of the measurement device from the message. The method 1300, in step 1330, compares the previously determined unique identification of the measurement device obtained from the message with the whitelisted previously determined unique identification. In step 1340, the method 1300, may determine if the previously determined unique identification of the measurement device obtained from the message matches the whitelisted previously determined unique identification.

As can be appreciated from the above discussion, the previously determined unique identification may be any suitable value, such as a serial number of the measurement device, a public key stored in a secured storage of the measurement device, etc. The previously determined unique identification of the measurement device may be compared to a whitelist, such as an identity whitelist, using any suitable manner. By way of illustration, where a serial number is obtained from the measurement device by a decentralized network data gateway, the decentralized network data gateway may determine that the unique identification is associated with a public key stored in a secured storage of the decentralized network data gateway, for example, in an identity whitelist.

As can be appreciated from the foregoing discussion, the comparison between the previously determined unique identification may or may not be a direct comparison. For example, the previously determined unique identification may be processed into, for example, a hash value that is compared to a hash value that is stored in the decentralized network data gateway. Alternatively, in another example, the previously determined unique identification may be consolidated with other values, such as other read-only register values of the measurement device, and compared to a corresponding stored value. However, as can be appreciated, any suitable method for comparing the previously determined unique identification to a whitelisted unique identification may be employed.

The message may further comprise at least one checksum of a measurement device data. Accordingly, the method 1300 may further comprise comparing the at least one checksum of the measurement device data with a signed checksum stored in a memory of the decentralized network data gateway. Additionally, the at least one checksum of a measurement device data may comprise at least one of a firmware checksum and a configuration checksum. The method 1300 may further comprise obtaining a whitelist containing the whitelisted previously determined unique identification from a cloud decentralized network. Additionally, the method 1300 may further comprise storing in a secure storage of the decentralized network data gateway the whitelist containing the whitelisted previously determined unique identification.

### Measurement Device and Decentralized Network Data Gateway

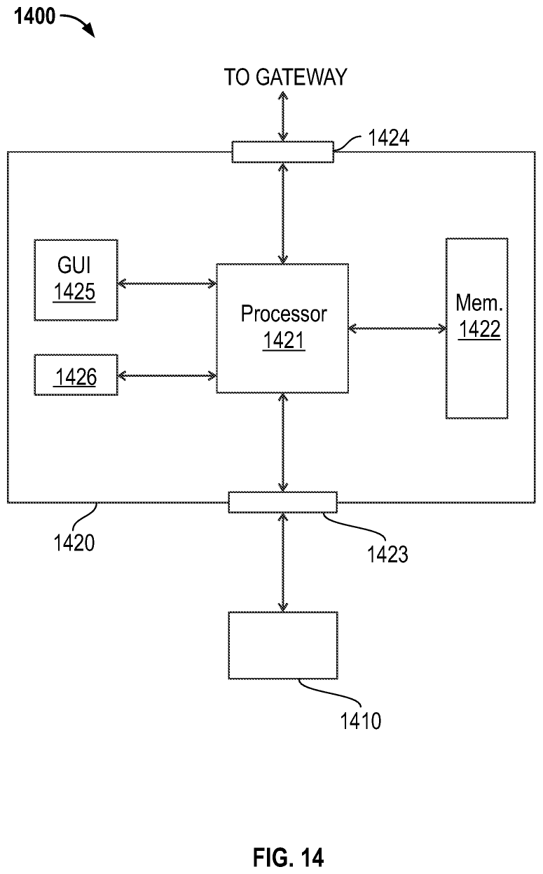

FIG. 14 shows a measurement device 1400 configured to form a message of the measurement device 1400. As shown in FIG. 14, the measurement device 1400 is comprised of a transducer 1410 and a device electronics 1420. The measurement device 1400 may be a representation of the measurement devices 220, 805 described above, or the like, although any suitable measurement device may be employed. As will be described in more detail in the following, the measurement device 1400 may be configured to perform various methods of forming a message from the measurement device 1400 for data validation, such as the method 1200 described above.

The transducer 1410 may be configured to sense physical properties. For example, the transducer 1410 may be configured to sense properties of a material, such as a fluid, or the like. For example, the transducer 1410 may be a Coriolis sensor assembly comprising one or more conduits containing a fluid, a fork density meter, an ultrasonic flow meter, or the like. The properties may be density, mass flow rate, volume flow rate, and/or the like. As can be seen in FIG. 14, the transducer 1410 is communicatively coupled to the device electronics 1420.

The transducer 1410 may be communicatively coupled to the device electronics 1420 using any suitable method. For example, the transducer 1410 may provide one or more signals, such as digital and/or analog signals, that represent values of one or more physical properties of, for example, a fluid sensed by the transducer 1410. The one or more signals may be provided in any suitable form. For example, the one or more signals may be superimposed, divided by channels, time division multiplexed, frequency division multiplexed, modulated, etc. The signals may or may not represent the physical property in units of the physical property. The one or more signals are provided to the device electronics 1420.

The device electronics 1420 may receive the one or more signals from the transducer 1410 and scale, adjust, denoise, etc., the one or more signals. Additionally, or alternatively, the device electronics 1420 may convert the one or more signals to measurement values that are in units of the physical property that is sensed by the transducer 1410. The device electronics 1420 may also be configured to format the measurement values to be provided to another device. For example, the device electronics 1420 may provide data to other devices in a format that is compliant with communications protocols, such as communications protocols of a controller-peripheral network.

As shown in FIG. 14, the device electronics 1420 is comprised of a processor 1421 that is communicatively coupled with a memory 1422. The processor 1421 is also communicatively coupled to an interface 1423 and a communications port 1424. The interface 1423 is shown as being communicatively coupled to the processor 1421. Additionally, the processor 1421 is communicatively coupled to a graphical user interface (“GUI”) 1425 and an input device 1426.

The processor 1421 may be any suitable processor such as a CPU executing an operating system and programs that operate through the operating system. For example, the processor 1421 may be a single CPU, multiple processors in a single chip, distributed across different circuits, a virtual instance on a virtual machine, and/or the like. The processor 1421 may be configured to process the one or more signals provided by the transducer 1410 to determine, for example, measurement values, convert the measurement values into a form suitable for communication, receive and/or provide input and/or output data, etc. Additionally, or alternatively, the processor 1421 may include circuits, such as application specific integrated circuits (“ASICs”) that can perform specific specialized tasks. For example, the processor 1421 may include circuits that encrypt and/or decrypt data to and/or from the memory 1422.

The processor 1421 may be configured to communicate with the memory 1422 so as to read and/or write from/to the memory 1422. Accordingly, the memory 1422 may provide data, such as measurement data, unique identifications, firmware number, configuration information, and/or the like. The memory 1422 may be configured to receive and store data provided by the processor 1421. The memory 1422 may be any suitable memory such as, for example, read-only memory (“ROM”), random-access memory (“RAM”), etc. The memory 1422 may also include or be comprised of secured memory. For example, portions of the memory 1422 may be encrypted such that only a separate secured operating system in the processor 1421 is able to access the encrypted portions of the memory 1422.

The interface 1423 may be any suitable interface that can receive and/or condition the one or more signals provided by the transducer 1410. For example, the interface 1423 may be comprised of analog filters, analog-to-digital converters (“ADC”), buffers, and/or the like. Accordingly, the interface 1423 may provide the received one or more signals to the processor 1421 in a form suitable for the processor 1421.

The GUI 1425 may receive and display data from the processor 1421. For example, the GUI 1425 may receive and display measurement values, checksum data, firmware number, configuration information, and/or the like. The input device 1426 may be any suitable input device such as a keyboard, pen, fingerprint reader, etc. More or fewer GUIs and input devices may be employed.

The measurement device 1400 may be configured to form a message. For example, the processor 1421 may obtain the previously determined unique identification of the measurement device 1400. For example, the processor 1421 may read the previously determined unique identification from one or more registers of the measurement device 1400. The previously determined unique identification of the measurement device 1400 may be one of a public key obtained from a decentralized network, such as the cloud decentralized network 820 described above, and a serial number obtained from the measurement device 1400. For example, the memory 1422 may store (e.g., securely) the previously determined unique identification of the measurement device 1400. The serial number of the measurement device may be previously associated with the public key. For example, as is described above in more detail, the decentralized network data gateway 810 may store an association between the serial number and the public key obtained from the cloud decentralized network 820.

Additionally, or alternatively, the measurement device 1400, or more particularly, the processor 1421, may obtain a checksum of the measurement device 1400 and combine the checksum with the previously determined unique identification of the measurement device 1400. The checksum may comprise one of a firmware checksum and a configuration checksum of the measurement device 1400. The processor 1421 may further secure the message for transmission over a secure channel to a cloud decentralized network. For example, the processor 1421 may secure the message for transmission to an internet-of-things hub communicatively coupled to the cloud decentralized network 820 described above, via a decentralized network data gateway, which is described in more detail in the following.

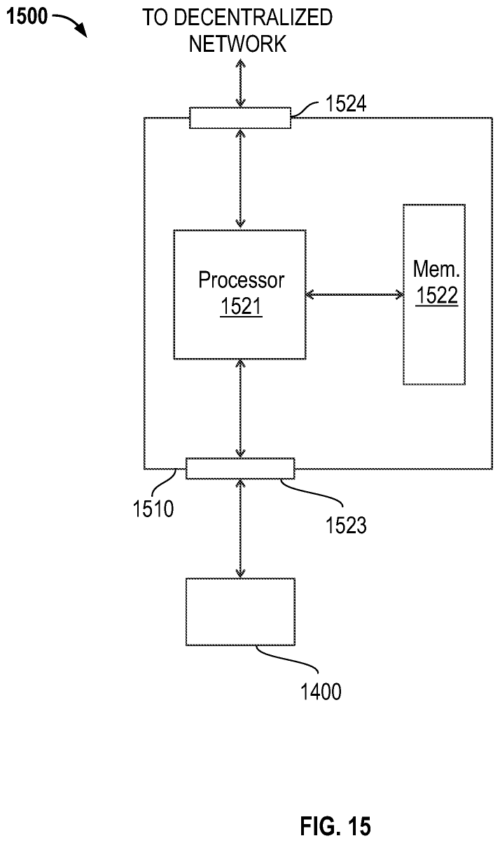

FIG. 15 shows a decentralized network data gateway 1500 configured to validate a message of a measurement device, such as the measurement device 1400 described above. As shown in FIG. 15, the decentralized network data gateway 1500 is comprised of a gateway server 1510 that is communicatively coupled to a measurement device 1400. The decentralized network data gateway 1500 may be a representation of the decentralized network data gateway 810 described above, although any suitable decentralized network data gateway may be employed. As will be described in more detail in the following, the decentralized network data gateway 1500 may be configured to perform various methods.

The measurement device 1400 may be communicatively coupled to the gateway server 1510 using any suitable communications means. For example, the measurement device 1400 may provide measurement data via one or more signals, such as digital and/or analog signals, that represent values of one or more physical properties of, for example, a fluid sensed by the measurement device 1400. The one or more signals may be provided in any suitable form. For example, the one or more signals may be superimposed, divided by channels, time division multiplexed, frequency division multiplexed, modulated, etc. The signals may or may not represent the physical property in units of the physical property. The one or more signals are provided to the gateway server 1510.

The gateway server 1510 may receive the one or more signals from the measurement device 1400 and scale, adjust, denoise, demodulate, etc., the one or more signals. Additionally, or alternatively, the gateway server 1510 may convert the one or more signals to measurement values that are in units of the physical property that is sensed by the measurement device 1400. The decentralized network data gateway 1500 may also be configured to format the measurement values to be provided to a decentralized network, such as the cloud decentralized network 820 described above. For example, the decentralized network data gateway 1500 may provide data to other devices in a format that is compliant with communications protocols, such as communications protocols of a controller-peripheral network.

As shown in FIG. 15, the gateway server 1510 is comprised of a processor 1521 that is communicatively coupled with a memory 1522. The processor 1521 is also communicatively coupled to an interface 1523 and a cloud communications port 1524. The interface 1523 is shown as being communicatively coupled to the processor 1521.

The processor 1521 may be any suitable processor such as a CPU executing an operating system and programs that operate through the operating system. For example, the processor 1521 may be a single CPU, multiple processors in a single chip, distributed across different circuits, a virtual instance on a virtual machine, and/or the like. The processor 1521 may be configured to process the one or more signals provided by the measurement device 1400 to determine, for example, measurement values, convert the measurement values into a form suitable for communication, receive and/or provide input and/or output data, etc. Additionally, or alternatively, the processor 1521 may include circuits, such as application specific integrated circuits (“ASICs”) that can perform specific specialized tasks. For example, the processor 1521 may include circuits that encrypt and/or decrypt data to and/or from the memory 1522.

The processor 1521 may be configured to communicate with the memory 1522 so as to read and/or write from/to the memory 1522. Accordingly, the memory 1522 may provide data, such as measurement data, unique identifications, firmware number, configuration information, and/or the like. The memory 1522 may be configured to receive and store data provided by the processor 1521. The memory 1522 may be any suitable memory such as, for example, read-only memory (“ROM”), random-access memory (“RAM”), or the like, and may be on a single circuit board, a virtual memory running on a server, or via cloud service, or the like. The memory 1522 may also include or be comprised of secured memory. For example, portions of the memory 1522 may be encrypted such that only a separate secured operating system in the processor 1521 is able to access the encrypted portions of the memory 1522.

The interface 1523 may be any suitable interface that can receive and/or condition the one or more signals provided by the measurement device 1400. For example, the interface 1523 may be comprised of analog filters, analog-to-digital converters (“ADC”), buffers, demodulators, and/or the like. Accordingly, the interface 1523 may provide the received one or more signals to the processor 1521 in a form suitable for the processor 1521.

The decentralized network data gateway 1500 may be configured to validate a message of a measurement device, such as the measurement device 1400 described above. For example, the processor 1521 of the decentralized network data gateway 1500 may receive the message from the measurement device and obtain, from the message, a previously determined unique identification of the measurement device. The processor 1521 may also compare the previously determined unique identification of the measurement device obtained from the message with a whitelisted previously determined unique identification and determine if the previously determined unique identification of the measurement device obtained from the message matches the whitelisted previously determined unique identification.

The message may further comprise at least one checksum of a measurement device data. Accordingly, the processor 1521 may compare the at least one checksum of the measurement device data with a signed checksum stored in the memory 1522 of the decentralized network data gateway 1500. The at least one checksum of a measurement device data may comprise at least one of a firmware checksum and a configuration checksum of the measurement device.

The decentralized network data gateway 1500 may also obtain a whitelist containing the whitelisted previously determined unique identification from a cloud decentralized network, such as the cloud decentralized network 820 described above. Accordingly, the decentralized network data gateway 1500 may store in a secure storage, such as a secure storage of the memory 1522, of the decentralized network data gateway 1500 the whitelist containing the whitelisted previously determined unique identification. As a result, the decentralized network data gateway can verify a message of the measurement device to ensure that the message is suitable for recordation in the cloud decentralized network.

The embodiments described above provide methods 1200, 1300, measurement device 1400, and a decentralized network data gateway that can form and validate a message of the measurement device 1400. The forming of the message of the measurement device 1400 may include combining a previously determined unique identification of the measurement device 1400 with the measurement data. As a result, the message may be verified as being from the measurement device 1400. Additionally, or alternatively, checksums may be compared to signed checksums to ensure that, for example, the measurement device 1400 is approved for providing data to the cloud decentralized network. As a result, data that is provided by the measurement device 1400, but by using a firmware or configuration not yet approved, may be automatically flagged as unapproved.

Additionally, or alternatively, the decentralized network data gateway 1500 may be configured to validate the message. By way of illustration, the decentralized network data gateway 1500 can compare the previously determined unique identification of the measurement device 1400 with a whitelisted unique identification that has been signed and recorded to the cloud decentralized network. Similarly, the decentralized network data gateway 1500 can compare the checksums of the message with signed checksums that are stored in the decentralized network data gateway 1500. Additionally, or alternatively, the decentralized network data gateway 1500 can sign the message with a private key of the decentralized network data gateway 1500 or the measurement device 1400. The private key may be securely stored in the decentralized network data gateway.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description.

Thus, although specific embodiments are described herein for illustrative purposes, various equivalent modifications are possible within the scope of the present description, as those skilled in the relevant art will recognize. The teachings provided herein can be applied to other methods that form and validate a message of a measurement device and not just to the embodiments described above and shown in the accompanying figures. Accordingly, the scope of the embodiments described above should be determined from the following claims.

We claim:

1. A method for forming a message from a measurement device for data validation, the method comprising:
obtaining a previously determined unique identification of the measurement device;
obtaining measurement data of the measurement device; and
combining the previously determined unique identification of the measurement device with the measurement data.

2. The method of claim 1, wherein obtaining the previously determined unique identification of the measurement device comprises reading the previously determined unique identification from one or more registers of the measurement device.

3. The method of claim 1, wherein the previously determined unique identification of the measurement device is one of a public key obtained from a decentralized network and a serial number obtained from the measurement device.

4. The method of claim 3, wherein the serial number of the measurement device is previously associated with the public key.

5. The method of claim 1, further comprising obtaining a checksum of the measurement device and combining the checksum with the previously determined unique identification of the measurement device.

6. The method of claim 5, wherein the checksum comprises one of a firmware checksum and a configuration checksum of the measurement device.

7. The method of claim 1, further comprising securing the message for transmission over a secure channel to a cloud decentralized network.

8. The method of claim 7, wherein securing the message for transmission over the secure channel to the cloud decentralized network comprises securing the message for transmission to an internet-of-things hub communicatively coupled to the cloud decentralized network.

9. A measurement device (1400) configured to form a message, the measurement device (1400) comprising:
a memory (1422) configured to store a unique identification of the measurement device (1400); and
a processor (1421) communicatively coupled to the memory (1422), the processor (1421) being configured to perform the method of claim 1.

10. A decentralized network data gateway (1500) configured to form a message, the decentralized network data gateway (1500) comprising:
a memory (1522) configured to store a unique identification of the measurement device (1500); and
a processor (1521) communicatively coupled to the memory (1522), the processor (1521) being configured to perform the method of claim 1.

11. A method for data validation of a message from a measurement device, the method comprising:
receiving the message from the measurement device;
obtaining, from the message, a previously determined unique identification of the measurement device;
comparing the previously determined unique identification of the measurement device obtained from the message with a whitelisted previously determined unique identification; and
determining if the previously determined unique identification of the measurement device obtained from the message matches the whitelisted previously determined unique identification.

12. The method of claim 11, wherein the message further comprises at least one checksum of a measurement device data.

13. The method of claim 12, further comprising comparing the at least one checksum of the measurement device data with a signed checksum stored in a memory of a decentralized network data gateway.

14. The method of claim 12, wherein the at least one checksum of the measurement device data comprises at least one of a firmware checksum and a configuration checksum.

15. The method of claim 12, further comprising obtaining a whitelist containing the whitelisted previously determined unique identification from a cloud decentralized network.

16. The method of claim 15, further comprising storing in a secure storage of a decentralized network data gateway the whitelist containing the whitelisted previously determined unique identification.

17. A decentralized network data gateway (1500) for validating a message from a measurement device (1400), the decentralized network data gateway (1500) comprising:
a memory (1522) configured to store a whitelist containing a whitelisted previously determined unique identification of the measuring device; and
a processor (1521) communicatively coupled to the memory (1522), the processor (1522) being configured to perform the method of claim 11.
